(19) United States
(12) Patent Application Publication
(10) Pub. No.: US 2007/0165579 A1
(43) Pub. Date: Jul. 19, 2007

(54) Method and device for accessing a mobile server terminal of a first communication network by means of a client terminal of another communication network

(75) Inventors: Yannick Delibie, Thorigne-Fouillard (FR); Christophe Billant, Saint Thual (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-les-Moulineaux Cedex (FR)

(21) Appl. No.: 10/577,298

(22) PCT Filed: Oct. 28, 2004
(86) PCT No.: PCT/FR04/02786

§ 371 Date: Dec. 27, 2006

(30) Foreign Application Priority Data
Oct. 30, 2003 (FR) 0312766

(51) Int. Cl. H04Q 7/24

(52) U.S. Cl. 370/338

(57) ABSTRACT

A method and apparatus are provided for enabling at least one client terminal, which is connected to a first communication network, to access the data and/or services of a mobile server terminal, which is connected to a second communication network. The first and second networks can coexist on or form a single network. One such method includes at least the following steps: a communication session is initialized by the client terminal with the mobile server terminal; and the communication session is established by opening a direct communication tunnel between the client terminal and the server terminal. In this way, the client terminal can consult the information made available by the server terminal and/or the client terminal can use and/or interact with all or part of the services of the server terminal.

### CROSS-REFERENCE TO RELATED APPLICATION

This Application is a Section 371 National Stage Application of International Application No. PCT/FR2004/002786, filed Oct. 28, 2004 and published as WO 2005/043847 on May 12, 2005, not in English.

### FIELD OF THE DISCLOSURE

The disclosure relates to the field of wireless applications.

The disclosure relates in particular, but not exclusively, to access by a stationary or mobile client terminal to a mobile server terminal, in order to use services and/or consult or update data, made available by the mobile server terminal.

### BACKGROUND

Today, mobile server terminals, such as mobile telephones or other portable radiocommunication terminals, are increasingly being used. The use of such mobile server terminals is, however, significantly limited by the fact that they must necessarily be connected to a private mobile network and that they can therefore be accessed only by stationary or mobile client terminals also connected to the same private network.

Indeed, it should be specified that any mobile communication network is made highly secure by means of one or more firewalls. Therefore, it is not possible to directly access a mobile server terminal that is connected to such a mobile communication network protected by this or these firewalls, from a stationary or mobile client terminal that does not belong to this same mobile network.

More specifically, and as shown in FIG. 1, no mobile server terminal 10 of a public land network 11 of an operator (PLMN for Public Land Mobile Network) can be accessed from a client terminal 13 of another external network 14, (the Internet, for example). Thus, only a client terminal belonging to the same public land network as a mobile server terminal can access and/or use the services of this mobile server terminal. Three primary technical constraints promote this situation:
first, on a public land network 11 of an operator (PLMN), any IP (Internet Protocol) address for identifying a server terminal is dynamically allocated. This dynamic IP address therefore exists only on the public land network having allocated it. It is therefore known only to the client terminals belonging to this same private public network, which are the only ones able to access and/or use the services of said mobile server terminal;
then, on a public land network of an operator (PLMN), a mechanism 15 for optimising the number of IP addresses used is implemented, which has the function of translating each public communication port solicited on the network into a private communication port only recognised by this network. Such a mechanism 15, more commonly known by the term NAT (for Network Address Translator) thus enables a private identifier to be dynamically allocated to each of the applications executed by each of the mobile server terminals of a single public land network;
finally, in the great majority of cases, the configuration of the firewalls 16 intended to protect a public land mobile network 11 is designed so as to prohibit any incoming TCP/IP (for Transmission Control Protocol/Internet Protocol) request 18.

### SUMMARY

An embodiment of the present invention is directed to a method for access, by at least one client terminal connected to a first communication network, to the data and/or services of a server terminal connected to a second communication network, wherein the first and second networks can cohabit or form a single network. One of the problems solved by an embodiment lies in particular in the fact that the server terminal is a mobile server terminal. Thus, such a method according to an embodiment of the invention advantageously includes at least the following steps:
initialization of a communication session by the client terminal with the mobile server terminal;
establishment of the communication session by opening a direct communication tunnel between the client terminal and the mobile server terminal;
   so that said client terminal can consult information made available by the mobile server terminal and/or the client terminal can use and/or interact with all or some of the services of the mobile server terminal.

The second communication network to which the mobile server terminal belongs is advantageously a wireless mobile communication network accessible via a security firewall.

The step of initialization of the communication preferably includes at least the following steps:
step A: sending a first TCP (Transmission Control Protocol) request from the client terminal to a domain name server;
step B: reception by the client terminal of a response to the first request, which contains at least one set of predetermined parameters for connection to a first public proxy server belonging to the first communication network;
step C: connection of the client terminal to the first public proxy server, by means of predetermined parameters, such as the IP address and/or communication port number;
step D: transmission by the first public proxy server of a request to initialise a communication session to a second private proxy server belonging to the second communication network in the form of an access request signal;
step E: sending a second TCP connection request by the second private proxy server, to a predetermined communication port of the mobile server terminal;
step F: transmission by the mobile server terminal of an acknowledgement of the second TCP connection request to the second private proxy server;
step G: sending a third TCP connection request by the second private proxy server to a predetermined communication port of the first public proxy server;
step H: transmission by the first public proxy server of an acknowledgement of the third TCP connection request to the second private proxy server;
step I: transmission by the first public proxy server of an acknowledgement of the first TCP connection request to the client terminal.

Thus, the successive sequence of these various steps advantageously makes it possible to initiate a communication session and to establish the opening of the direct communication tunnel between the client terminal and the mobile server terminal, wherein the tunnel passes through the security firewall(s) of the network on which the mobile server terminal is connected.

The access request signal transmitted by the client terminal is preferably of the type belonging to the group including at least:
an SMS message;
an e-mail message;
   and includes a list of predetermined parameters.

The list of predetermined parameters advantageously includes at least parameters of the type belonging to the group including at least:
an IP address for identification of the first public proxy server at the origin of the access request signal;
a communication port number for additional identification of the first public proxy server at the origin of the access request signal;
at least one key for securing the communication initialization request step.

In a preferred embodiment of the invention, the list of predetermined parameters also advantageously includes at least one additional parameter corresponding to a unique call number of the second server terminal, when the access request signal is an SMS message, and/or corresponding to the type of the communication tunnel security protocol.

In an alternative of the preferred embodiment of the invention, the list of predetermined parameters also includes at least one additional parameter corresponding to an e-mail address of the second server terminal, when the access request signal is of the e-mail message type.

The security key is preferably a negotiation and/or encryption key.

In a preferred embodiment of the invention, the communication tunnel established between the client terminal and the mobile server terminal advantageously includes HTTP-type authentication means.

The communication tunnel established between the client terminal and the mobile server terminal advantageously includes secure data transmission means of the type using at least:
the IPSEC protocol;
the communication tunnel encryption protocol.

Another embodiment of the invention advantageously relates to a device for communication and/or radiocommunication between at least one client terminal and one mobile server terminal, characterised in that it implements the aforementioned method for access, by at least one client terminal connected to a first communication network, to the data and/or services of a server terminal connected to a second communication network, wherein the first and second networks can cohabit or form a single network.

Also advantageously, the method according to an embodiment of the invention is applied to a variety of fields belonging to the group including at least:
wireless applications using Web services;
on-board telemedicine applications enabling a doctor to regularly access the mobile telephone serving as a mobile server terminal, so as to access and monitor the data of a patient, who is the owner of said mobile telephone;
distributed interactive applications of the type including at least:
   distributed games;
   on-board collaborative work applications on communicating mobile terminals.

Other features and advantages will become more clear from the following description of a preferred embodiment, given by way of a simple illustrative and non-limiting example, and the appended drawings.

### BRIEF DESCRIPTION OF THE DRAWINGS

FIG. 1 shows the current situation of the prior art relating to the impossibility for a client terminal (stationary or mobile) connected to the Internet, to access a mobile server terminal of a PLMN public land mobile network protected by at least one firewall and at least one translator for translating public network address into private network addresses (NAT for Network Address Translator).

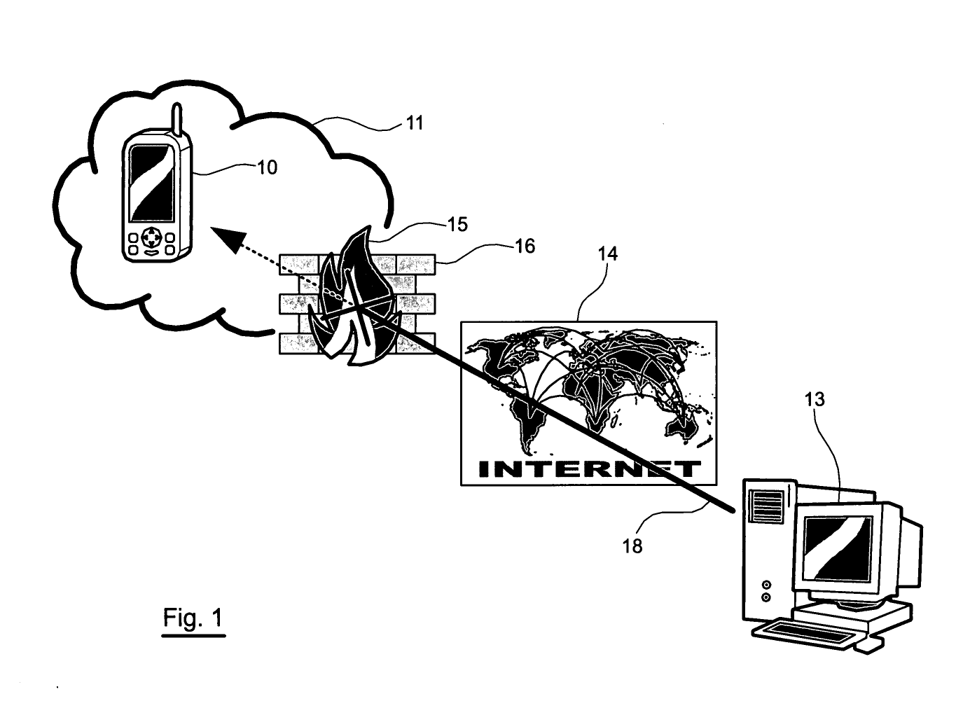

FIG. 2 shows the various technical components and the various steps for initialization of a communication session occurring in the device and the method according to an embodiment of the invention, respectively.

FIG. 3 is a diagram of sequences showing the various steps of initialization of a communication session leading to the opening of a communication tunnel between a client terminal of a first communication network and a mobile server terminal of another communication network.

FIG. 4 shows the diagram of communication between a client terminal of a first communication network and a mobile server terminal belonging to a second secure private network, following the initialization of a communication session and the opening of a communication tunnel passing through the firewall and the address translator of said private network, by means of the method according to an embodiment of the invention.

### DETAILED DESCRIPTION OF ILLUSTRATIVE EMBODIMENTS

The term wireless application refers, according to a commonly accepted definition, to any type of real-time on-board applications requiring, for communication, a connection to a wireless and/or mobile network, such as a GSM, GPRS, and/or UMTS network, for example, other than mobile telephone and “hands-free” applications.

One or more embodiments of the invention relate to mobile server terminals executing such wireless applications intended to make various types of information and/or different types of service accessible to other stationary and/or remote mobile clients. These different types of services can either be specific and relate to only a restricted group of individuals, or be general and/or public, and thus be potentially accessible to any individual (Web page consultation on the Internet, for example).

Thus, an embodiment of the invention relates in particular, but not exclusively, to access by a stationary or mobile client terminal to a mobile server terminal, in order to use services and/or consult or update data, made available by the mobile server terminal.

By way of an illustrative and non-limiting example, an embodiment thus applies in particular but not exclusively to fields as varied as:
the automotive industry;
point-to-point applications such as machine-to-machine (M2M) applications;
telemedicine applications on-board mobile terminals;
the consultation of Web pages made available by a mobile server terminal.

An embodiment of the invention provides a method for access to the services or data of a mobile server terminal of a public land network by means of a client terminal (stationary or mobile) connected to a different communication network, such as the Internet. Such a method is based in particular on the use of an SMS (Short Message Service) message or an e-mail message by the client terminal, in order to request the initialization of a communication session with said mobile server terminal. The initialization of such a session results in particular in the establishment of a communication tunnel between the client terminal and the mobile server terminal, which securely passes through the firewall and the network address translator (NAT).

Various embodiments of the invention can be technically envisaged, one of which is described in greater detail below.

A preferred embodiment of the invention is based on an original approach making it possible to authorise, for the purpose of security, the initialization of a communication session between a mobile server terminal of a public land network (PLMN) and a client terminal of another network, as if the client terminal belonged to said public land network.

This approach is based in particular on a relevant and original use of SMS (Short Message Service) messages including a set of parameters, in order to directly transmit to the proxy server of said public land network a request for initialization of communication with a previously identified mobile server terminal, which thus makes it possible to overcome the problem according to the prior art associated with the transmission of a TCP/IP request. Indeed, any request of this type for initialization of a communication session with a mobile terminal of a PLMN would in every case be blocked by the firewall and the network address translator of said PLMN.

The method according to an embodiment of the invention advantageously relates to the initialization of a communication session by the client terminal with the mobile server terminal, and the establishment of a communication session by opening a direct communication tunnel between the client terminal and the server terminal. The opening of such a direct tunnel thus enables the client terminal to consult information made available by the server terminal and/or to use and interact with all or some of the services of the server terminal.

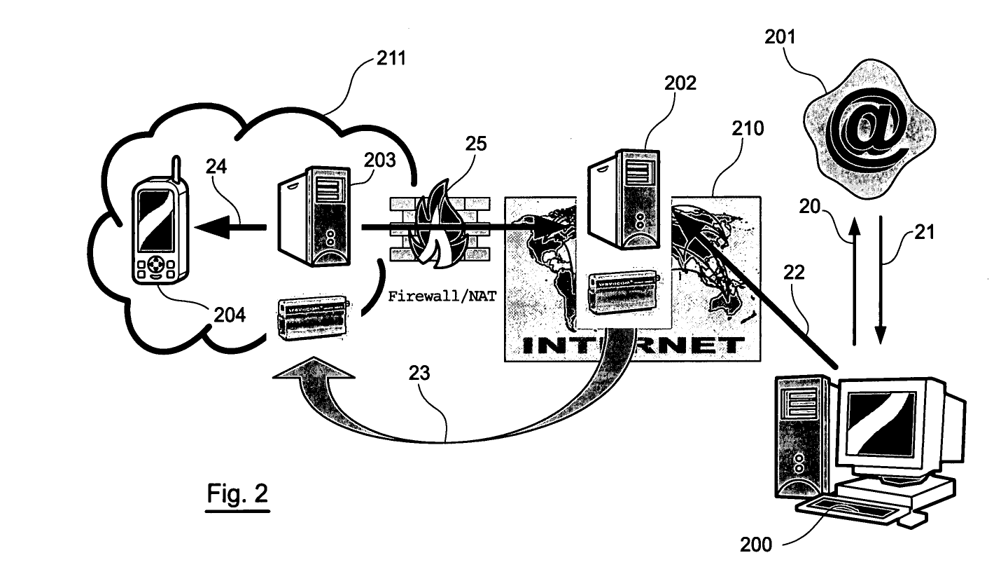

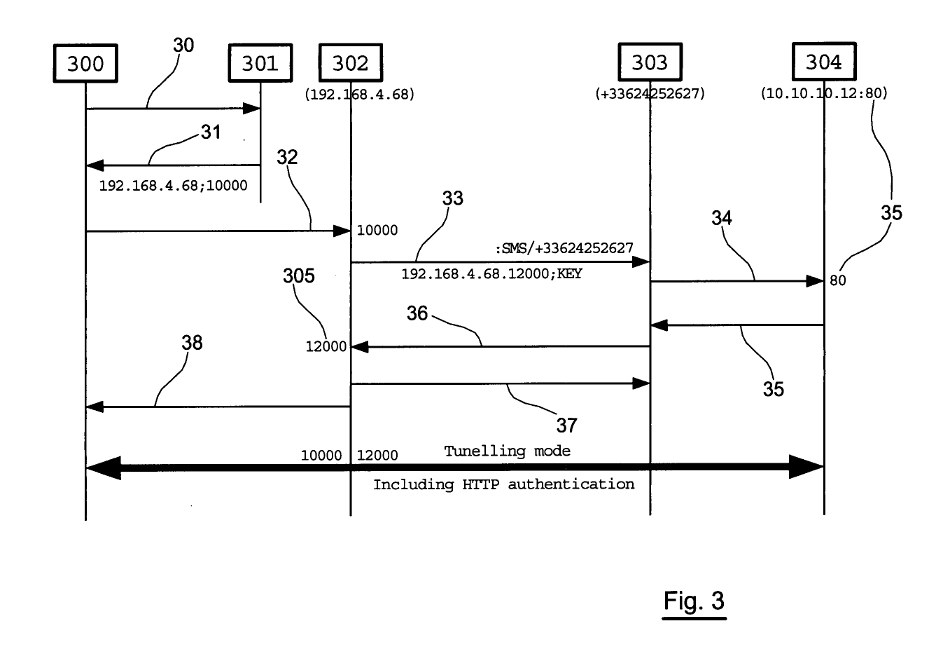

As shown in FIGS. 2 and 3, the communication initialization step includes at least the following series of steps:
step A: sending a first TCP (Transmission Control Protocol) request 20, 30 from the client terminal 200, 300 to a domain name server 201, 301;
step B: reception by the client terminal 200, 300 of a response 21, 31 to the first request 20, 30, which contains at least one set of predetermined parameters for connection to a first public proxy server 202, 302 belonging to the first communication network 210;
step C: connection 22, 32 of the client terminal 200, 300 to the first public proxy server 202, 302, by means of the predetermined parameters, of the IP address and/or communication port number type;
step D: transmission by the first public proxy server 202, 302 of a request 23, 33 to initialise a communication session to a second private proxy server 203, 303 belonging to the second communication network 211 in the form of an access request signal;
step E: sending a second TCP connection request 24, 34 by the second private proxy server 203, 204, to a predetermined communication port 35 of the mobile server terminal 204, 304;
step F: transmission by the mobile server terminal 204, 304 of an acknowledgement 35 of the second TCP connection request 24, 34 to the second private proxy server 203, 303;
step G: transmission of a third TCP connection request 36 by the second private proxy server 203, 303 to a predetermined communication port 305 of the first public proxy server 202, 302;
step H: transmission by the first public proxy server 202, 302 of an acknowledgement 37 of the third TCP connection request 36 to the second private proxy server 203, 303;
step I: transmission by the first public proxy server 202, 302 of an acknowledgement 38 of the first TCP connection request 20, 30 to the client terminal 200, 300.

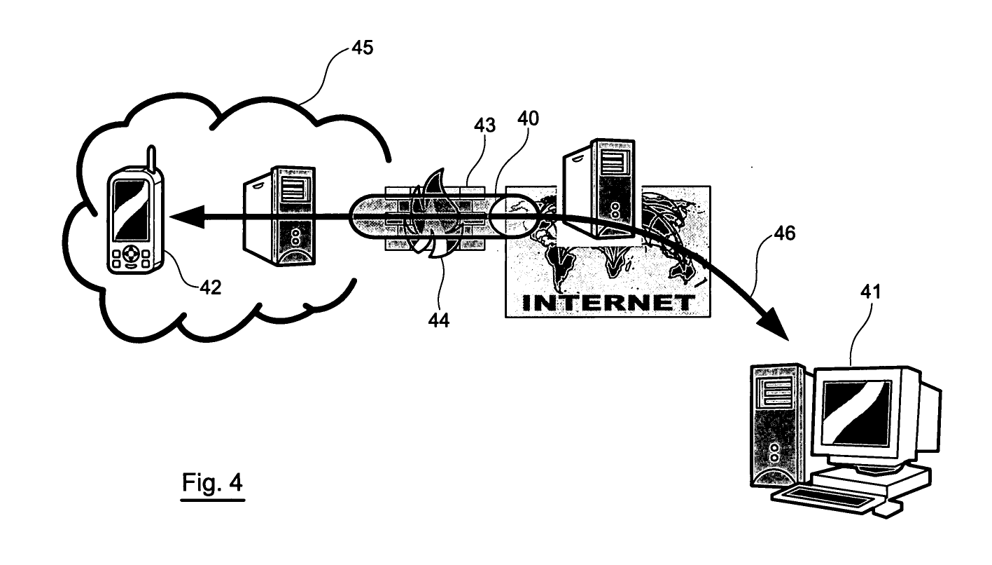

Thus, as shown in FIG. 4, the series of these various steps makes it possible to initiate a communication session and to establish the opening of a direct communication tunnel 40 between the client terminal 41 and the mobile server terminal 42. In the method according to an embodiment of the invention, the communication tunnel 40 thus opened passes through the firewall(s) 43 and network address translators 44 for securing the private PLMN network 45 on which the mobile server terminal 42 is connected. The client terminal 41 is then capable of directly communicating, in point-to-point mode 46, with the mobile server terminal 42 and of using the services or data made available by the latter.

It is understood that, in FIG. 3, the communication ports referenced 35 and 305 are shown by way of a non-limiting example, and other communication port numbers can be used indifferently depending on the network configurations encountered.

Such a method according to an embodiment of the invention thus makes it possible for any client terminal of a communication network, such as the Internet, for example, to connect to a mobile client terminal of a PLMN public land network, as if it actually belonged to this public land network secured by firewalls and network address translators (NAT).

Moreover, it is important to emphasise that the sequence of steps for initialization of a communication session can be secured by encryption means with one or more public and private keys. Indeed, it is technically possible to consider encapsulating and encrypting predetermined parameters contained in the SMS message making it possible to establish the opening of a communication session and the associated communication tunnel.

In an alternative of the preferred embodiment mentioned above, the client terminal does not transmit an SMS directly to the private proxy server of the PLMN public land network, but transmits, to this private proxy server, an e-mail message secured by encryption means, which contains at least the same information for requesting the establishment of the communication session as that contained in the SMS message of the aforementioned preferred embodiment:
an IP address for identification of the first public proxy server at the origin of the access request signal;
a communication port number for additional identification of the first public proxy server at the origin of the access request signal;
at least one security key for the communication initialization request step.

In the two embodiments of the invention mentioned above, the list of predetermined parameters also includes at least one additional parameter corresponding to a unique call number of the second server terminal, when the access request signal is an SMS message, and/or corresponding to the communication tunnel security protocol.

The method and device for access, by at least one client terminal connected to a first communication network, to the data and/or services of a mobile server terminal connected to a second highly-secure communication network, as proposed by an embodiment of the invention, have a number of advantages, of which a non-exhaustive list is provided below:
improvement of the convergence between point-to-point applications, more commonly known by the acronym M2M machine-to-machine and Internet applications and/or Web services;
the possibility of introducing new wireless applications or new value-added services to mobile servers. Such applications may in particular concern, by way of a non-limiting example, telemedicine. Indeed, an embodiment of the invention makes it possible to consider new telemedicine applications that would enable, for example, a diabetic patient to directly indicate his glycaemia over his mobile telephone, and the doctor must simply perform a secure query of the data of his patient over the mobile telephone of the latter, which serves as a mobile server terminal.

One or more embodiments of the invention provide a technique making it possible to communicate with a mobile server terminal from a first public land network (PLMN), from a stationary or mobile client terminal of a second public land network, in spite of the aforementioned technical security constraints of said first network.

In other words, an embodiment of the invention provides a technique making it possible to access the services and/or information of a mobile server terminal of a first public land mobile network of an operator, from a stationary or mobile client terminal not necessarily belonging to the same first network. It should be noted that the formulation of this problem, which also is contrary to the conventional practice of a person skilled in the art, is, per se, a part of an embodiment of the invention.

An embodiment of the invention provides such a technique that does not use the conventional connection methods of the prior art essentially based on TCP/IP request exchanges in order to establish a communication session with a mobile server terminal, from a client terminal.

An embodiment of the invention provides such a technique that can integrate various levels of security, in terms of initialization of a communication session with a mobile server terminal of a first land communication network, and in terms of access to the services and/or information of said mobile server terminal, from another stationary or mobile terminal not belonging to the same first network.

An embodiment of the invention further provides such a technique that also makes it possible to overcome the technical security constraints of the prior art mentioned above in the establishment of a communication session between a mobile server terminal belonging to a first public land network (PLMN) and a client terminal belonging to another network, but wanting to access or use the data and/or services of said mobile server terminal.

An embodiment of the invention yet further provides such a technique that promotes the technical convergence between wireless or mobile M2M applications and Internet services.

An embodiment of invention provides such a technique that is simple and inexpensive to implement.

Although the present invention have been described with reference to preferred embodiments, workers skilled in the art will recognize that changes may be made in form and detail without departing from the spirit and scope of the invention.

1. A method for access, by at least one client terminal connected to a first communication network, to the data and/or services of a server terminal connected to a second communication network, wherein said first and second networks can cohabit or form a single network, wherein said server terminal is a mobile terminal, and said method includes at least the following steps:
initialization of a communication session by the client terminal with the mobile server terminal;
establishment of the communication session by opening a direct communication tunnel between the client terminal and the mobile server terminal;
so that said client terminal can consult information made available by the mobile server terminal and/or the client terminal can use and/or interact with all or some of the services of the mobile server terminal.

2. The method for access according to claim 1, wherein said second communication network comprises a wireless mobile communication network accessible through a security firewall.

3. The method for access according to claim 1, wherein said communication initialization step includes at least the following series of steps:
step A: sending a first TCP (Transmission Control Protocol) request from the client terminal to a domain name server;
step B: reception by the client terminal of a response to the first request, which contains at least one set of predetermined parameters for connection to a first public proxy server belonging to the first communication network;
step C: connection of the client terminal to the first public proxy server, by means of predetermined parameters, such as the IP address and/or communication port number;
step D: transmission by the first public proxy server of a request to initialise a communication session to a second private proxy server belonging to the second communication network in the form of an access request signal;
step E: sending a second TCP connection request by the second private proxy server, to a predetermined communication port of the mobile server terminal;
step F: transmission by the mobile server terminal of an acknowledgement of the second TCP connection request to the second private proxy server;
step G: sending a third TCP connection request by the second private proxy server to a predetermined communication port of the first public proxy server;
step H: transmission by the first public proxy server of an acknowledgement of the third TCP connection request to the second private proxy server;
step I: transmission by the first public proxy server of an acknowledgement of the first TCP connection request to the client terminal;
so as to initiate said communication session and establish the opening of said direct communication tunnel between the client terminal and the mobile server terminal, wherein said tunnel passes through said security firewall.

4. The method for access according to claim 3, wherein said access request signal transmitted by said client terminal is of the type belonging to the group including at least:
an SMS message; and
an e-mail message;
and wherein said access request signal includes a list of predetermined parameters.

5. The method for access according to claim 4, wherein said list of predetermined parameters includes at least parameters of the type belonging to the group including at least:
an IP address for identification of the first public proxy server at the origin of the access request signal;
a communication port number for additional identification of the first public proxy server at the origin of the access request signal; and
at least one key for securing the communication initialization request step.

6. The method for access according to claim 4, wherein said list of predetermined parameters includes at least one parameter corresponding to a unique call number of the second server terminal, when said access request signal comprises an SMS message, and/or corresponding to the type of the communication tunnel security protocol.

7. The method for access according to claim 4, wherein said list of predetermined parameters includes at least one parameter corresponding to an e-mail address of said second server terminal, when said access request signal is of the e-mail message type.

8. The method for access according to claim 5, wherein said security key is a negotiation and/or encryption key.

9. The method for access according to claim 1, wherein said communication tunnel established between said client terminal and said mobile server terminal includes http-type authentication means.

10. The method for access according to claim 1, wherein said communication tunnel established between said client terminal and said mobile server terminal includes secure data transmission means of the type using at least:
an IPSEC protocol; and
a communication tunnel encryption protocol.

11. (canceled)

12. The method of claim 1 and further comprising performing the steps of claim 1 in a field belonging to the group including at least:
wireless applications using Web services;
on-board telemedicine applications enabling a physician to regularly access a mobile telephone serving as a mobile server terminal, so as to access and monitor the data of a patient, who is the owner of said mobile telephone;
distributed interactive applications of the type including at least:
distributed games;
on-board collaborative work applications on communicating mobile terminals.

13. A client terminal for communication and/or radiocommunication between with at least one mobile server terminal, wherein the client terminal comprises:
means for initializing a communication session by the client terminal with the mobile server terminal; and
means for establishing the communication session by opening a direct communication tunnel between the client terminal and the mobile server terminal;
so that said client terminal can consult information made available by the mobile server terminal and/or the client terminal can use and/or interact with all or some of the services of the mobile server terminal.

14. A mobile server terminal for communication and/or radiocommunication between with at least one client terminal, wherein the mobile server terminal comprises:
means for receiving a request from the client terminal to initialize a communication session between the client terminal and the mobile server terminal; and
means for establishing the communication session by opening a direct communication tunnel between the client terminal and the mobile server terminal;
so that said client terminal can consult information made available by the mobile server terminal and/or the client terminal can use and/or interact with all or some of the services of the mobile server terminal.
